(19) United States
(12) Patent Application Publication
(10) Pub. No.: US 2024/0423201 A1
(43) Pub. Date: Dec. 26, 2024

(54) MULTI-TEMPERATURE ZONE MOSQUITO PREVENTION AND CONTROL TABLET

(71) Applicant: Wenjie LI, Guangzhou (CN)

(72) Inventor: Wenjie LI, Guangzhou (CN)

(21) Appl. No.: 18/506,091

(22) Filed: Nov. 9, 2023

(30) Foreign Application Priority Data
Jun. 20, 2023 (CN) 2023107407376

(51) Int. Cl. A01N 25/34; A01M 1/20; A01M 29/00; A01N 25/18; A01N 35/02; A01N 37/10; A01N 37/22; A01N 43/40; A01N 53/00; A01P 7/04; A01P 17/00

(52) U.S. Cl. CPC A01N 25/34; A01M 1/2022; A01M 29/00; A01N 25/18; A01N 35/02; A01N 37/10; A01N 37/22; A01N 43/40; A01N 53/00; A01P 7/04; A01P 17/00

(57) ABSTRACT

The present application relates to a multi-temperature zone mosquito prevention and control tablet, including a tablet substrate; a middle portion of the tablet substrate is provided with a first drug zone, and two sides of the tablet substrate are provided with a second drug zone; the first drug zone is filled with pyrethroid, and the second drug zone is filled with a repellent drug; and the repellent drug includes picaridin, dimethyl phthalate, methyl nonyl ketone, and diethylmethylbenzamide. The present application may diffuse different repellent drugs in combination, to achieve the composite mosquito prevention and control effect; and in addition, the present application only needs to heat the first drug zone and does not increase the energy consumption of an electric mosquito killer used in combination.

### CROSS-REFERENCE TO RELATED APPLICATIONS

This application claims priority to Chinese Patent Application No. 202310740737.6, filed on Jun. 20, 2023, which are incorporated herein by reference in their entirety.

### TECHNICAL FIELD

The present application relates to the technical field of mosquito prevention and control, in particular to a multi-temperature zone mosquito prevention and control tablet.

### BACKGROUND

A mosquito prevention and control problem is one of the problems that may not be ignored in people's daily life, and an electric mosquito killer using tablets becomes a commonly used mosquito repellent device due to the lack of open flame, easy portability and other reasons. Usually the working temperature and deviation of the electric heater are (165±8° C.), and (pyrethroid) pyrethrin needs to be electric-heated to combustion-heated to “165±8° C.” so as to achieve the best mosquito killing effect. Therefore, mosquito killing apparatuses mainly composed of the (pyrethroid) pyrethrin are difficult to achieve lightweight. However, heated mosquito killing apparatuses powered by combustible gases have many limitations in travel and transportation processes. In addition, due to the different optimal working temperatures of various mosquito repellent drugs, the tablet used for the electric mosquito killer in existing technologies usually only includes one effective component, it needs to be placed in a heating zone of the electric mosquito killer, and uniformly heated throughout the entire zone to diffuse the drugs in the tablet. In other words, the tablet used in combination with the electric mosquito killer in the existing technologies may only diffuse a single effective drug and may not simultaneously diffuse a plurality of the drugs to achieve the combined effect of mosquito repelling and mosquito killing.

### SUMMARY

The present application provides a multi-temperature zone mosquito prevention and control tablet, as to solve the problem that the tablet used in combination with the electric mosquito killer in the existing technologies may only diffuse a single effective drug and may not simultaneously diffuse a plurality of the drugs to achieve the combined effect of mosquito repelling and mosquito killing.

In order to achieve the above purpose, the present application adopts the following technical schemes.

A multi-temperature zone mosquito prevention and control tablet, including a tablet substrate.

A middle portion of the tablet substrate is provided with a first drug zone, and two sides of the tablet substrate are provided with a second drug zone.

The first drug zone is filled with pyrethroid, and the second drug zone is filled with a repellent drug.

The repellent drug includes picaridin, dimethyl phthalate, methyl nonyl ketone, and diethylmethylbenzamide.

Further, the tablet substrate is made of a hydrophilic material.

Further, two second drug zones are symmetrically arranged on both sides of the tablet substrate.

Further, the repellent drug in the second drug zone is the picaridin.

An electric mosquito killer, used to heat the above multi-temperature zone mosquito prevention and control tablet, herein the electric mosquito killer is provided with a heating unit, and the heating unit is used to heat the first drug zone of the tablet substrate.

Further, the electric mosquito killer is provided with a slot matched with the tablet substrate.

The beneficial effects of the present application are as follows.

1. The different repellent drugs may be diffused in combination, to achieve the composite mosquito prevention and control effects.

2. The working temperature of the drug in the first drug zone is higher than the working temperature of the drug in the second drug zone. Only the first drug zone is heated, and then the temperature is diffused by the tablet substrate, thereby the drug in the second drug zone is heated without increasing the energy consumption of the electric mosquito killer used in combination.

### BRIEF DESCRIPTION OF THE DRAWINGS

FIG. 1 is an overall schematic diagram of a multi-temperature zone mosquito prevention and control tablet;

FIG. 2 is a front-view diagram of the multi-temperature zone mosquito prevention and control tablet mounted on an electric mosquito killer; and

FIG. 3 is a left-view diagram of the multi-temperature zone mosquito prevention and control tablet mounted on the electric mosquito killer by a slot.

### DETAILED DESCRIPTION OF THE EMBODIMENTS

In order to make purposes, technical schemes, and advantages of the present application clearer, the technical schemes of the present application are further clearly and completely described below in combination with embodiments of the present application. It should be noted that the embodiments described are only a part of the embodiments of the present application, not all of the embodiments. Based on the embodiments in the present application, all other embodiments obtained by those of ordinary skill in the art without creative labor shall fall within the scope of protection of the present application.

It should be noted that if a directional indication (such as up, down, left, right, front, back, top, bottom, inside, outside, vertical, horizontal, longitudinal, counterclockwise, clockwise, circumferential, radial, and axial) is involved in the embodiments of the present application, the directional indication is only used to explain a relative position relationship, a motion situation and the like between various components in a specific posture (as shown in the drawings). If the specific posture is changed, the directional indication is also changed accordingly with it.

The term “and/or” in the embodiments of the present application is only a description of an association relationship of associated objects, it is indicated that there may be three types of relationships, for example, A and/or B, it may indicate: the existence of A alone, the existence of A and B simultaneously, and the existence of B alone.

The terms “first” and “second” in the embodiments of the present application are only used for descriptive purposes and may not be understood as indicating or implying the relative importance or implying the quantity of technical features indicated. Therefore, features limited to “first” and “second” may explicitly or implicitly include at least one of these features. In the description of the present application, the terms “including” and “having” and any variations thereof are intended to cover non-exclusive inclusion. For example, a system, a product, or a device that contains a series of components or units is not limited to the listed components or units, but optionally includes unlisted components or units, or optionally includes other components or units inherent to these products or devices. In the description of the present application, “plurality” means at least two, for example two and three, unless otherwise specified.

The reference to “embodiments” in this article means that specific features, structures, or characteristics described in combination with the embodiments may be contained in at least one embodiment of the present application. The phrase appearing in various positions in the description does not necessarily refer to the same embodiment, nor is it an independent or alternative embodiment that is mutually exclusive with other embodiments. Those skilled in the art explicitly and implicitly understand that the embodiments described in this article may be combined with other embodiments.

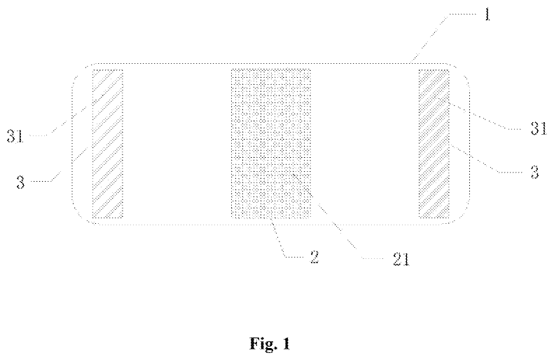

As shown in FIG. 1, the present application provides a multi-temperature zone mosquito prevention and control tablet, it is mainly composed of a tablet substrate 1 filled with a drug for mosquito repelling and mosquito killing, and the tablet substrate 1 is made of a hydrophilic material (such as a plant fiber material and a porous foam material), and is in the shape of tablets (tablet-like).

A middle portion of the tablet substrate 1 is provided with a first drug zone 2, and two sides of the tablet substrate 1 are symmetrically provided with a second drug zone 3. When the tablet of the present application is used, only the first drug zone 2 needs to be heated, the heating temperature of the first drug zone 2 is controlled, and the tablet substrate 1 itself has the thermal conductivity and may transfer heat to the second drug zone 3 on both sides. The tablet substrate 1 has the thermal resistance, and there is a certain loss when the heat is transferred to the second drug zone 3, so that the heating temperature of the second reagent zone 3 may be lower than that of the first drug zone 2; and on the basis of controlling the heating temperature of the first drug zone 2 by an external heat source, the temperature of the second drug zone 3 may be indirectly controlled by controlling a distance between the second drug zone 3 and a centerline of the tablet substrate 1, namely the distance between the second drug zone 3 and the first drug zone 2. At the same time, the second drug zone 3 is located on both sides of the tablet substrate 1, directly in contact with the air, which may transfer the heat to the air, so that a larger temperature difference between the first drug zone 2 and the second drug zone 3 may be further produced, and the second drug zone 3 has the better volatilization effect.

In existing technologies, drugs commonly used for mosquito prevention and control include pyrethroid (such as prallethrin, meperfluthrin, dimefluthrin, and permethrin), picaridin, dimethyl phthalate, methyl nonyl ketone, diethylmethylbenzamide and the like, herein the pyrethroid has a relatively high melting point and require a relatively high working temperature, and belongs to mosquito killing drugs, while the picaridin, dimethyl phthalate, methyl nonyl ketone, and diethylmethylbenzamide have a relatively low working temperature at the room temperature (25° C.), and all of which belong to mosquito repelling drugs with relatively low toxicity. Moreover, the optimal diffusion temperature ranges of the above mosquito repelling drugs are close.

In conclusion, the first drug zone 2 is filled with the pyrethroid 21, the second drug zone 3 is loaded with a repellent drug 31, and the repellent drug 31 is one of the picaridin, dimethyl phthalate, methyl nonyl ketone, and diethylmethylbenzamide.

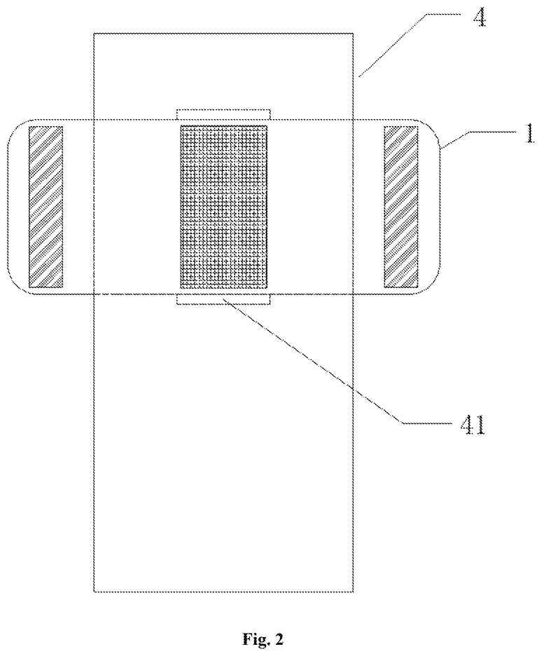

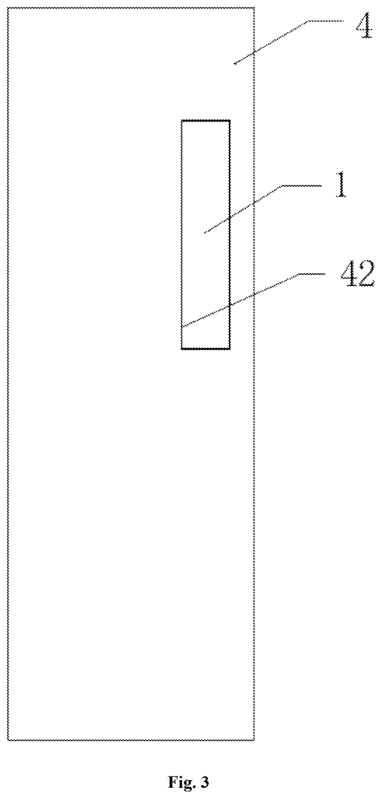

As shown in FIG. 2, a state of the multi-temperature zone mosquito prevention and control tablet of the present application mounted on an electric mosquito killer is shown. The electric mosquito killer 4 is provided with a heating unit 41, and the heating unit 41 is used to heat the first drug zone 2 of the drug substrate 1. As shown in FIG. 3, the electric mosquito killer fixes the drug substrate 1 by arranging a slot 42, the drug substrate 1 may be inserted into the slot 42 from a side surface of the electric mosquito killer 4, the heating unit 41 only heats the first drug zone 2, and the second drug zone 3 at both ends is heated by using the diffused temperature. A plurality of drugs is diffused simultaneously, and at the same time, because only the first drug zone 2 needs to be heated, the energy consumption is also saved actually.

In a preferred embodiment of the present application, the repellent drug 31 filled in the second drug zone 3 is the picaridin.

The above embodiments only express implementation modes of the present application, and its descriptions are more specific and detailed, but may not be understood as limiting the scope of the present application. It should be pointed out that for those of ordinary skill in the art, a plurality of deformations and improvements may also be made without departing from the concept of the present application, all of which shall fall within the scope of protection of the present application. Therefore, the scope of protection of the present application should be based on the appended claims.

What is claimed is:

1. A multi-temperature zone mosquito prevention and control tablet, characterized by comprising a tablet substrate;
a middle portion of the tablet substrate is provided with a first drug zone, and two sides of the tablet substrate are provided with a second drug zone;
the first drug zone is filled with pyrethroid, and the second drug zone is filled with a repellent drug; and
the repellent drug comprises picaridin, dimethyl phthalate, methyl nonyl ketone, and diethylmethylbenzamide.

2. The multi-temperature zone mosquito prevention and control tablet according to claim 1, characterized in that the tablet substrate is made of a hydrophilic material.

3. The multi-temperature zone mosquito prevention and control tablet according to claim 1, characterized in that two second drug zones are symmetrically arranged on both sides of the tablet substrate.

4. The multi-temperature zone mosquito prevention and control tablet according to claim 1, characterized in that the repellent drug in the second drug zone is the picaridin.

5. An electric mosquito killer, used to heat the multi-temperature zone mosquito prevention and control tablet according to claim 1, characterized in that the electric mosquito killer is provided with a heating unit, and the heating unit is used to heat the first drug zone of the tablet substrate.

6. The electric mosquito killer according to claim 5, characterized in that the electric mosquito killer is provided with a slot matched with the tablet substrate.
